(19) United States
(12) Patent Application Publication
(10) Pub. No.: US 2013/0185280 A1
(43) Pub. Date: Jul. 18, 2013

(54) MULTI-JOIN DATABASE QUERY

(71) Applicants: Ding MA, Singapore (SG); Shi Xing Yan, Singapore (SG); Guopeng Zhao, Singapore (SG); Bu Sung Lee, Singapore (SG)

(72) Inventors: Ding MA, Singapore (SG); Shi Xing Yan, Singapore (SG); Guopeng Zhao, Singapore (SG); Bu Sung Lee, Singapore (SG)

(21) Appl. No.: 13/349,366

(22) Filed: Jan. 12, 2012

(51) Int. Cl. G06F 17/30

(52) U.S. Cl. 707/714; 707/E17.054

(57) ABSTRACT

A method includes performing a query of a database. The query includes joining a first Domain-Model-sub-class table with a Domain-Model table based on identity attributes present in both the first Domain-Model-sub-class table and Domain-Model table to produce a first joined table. The query further includes joining the first joined table with an access control list (ACL) entry table based on an ACL object identity attribute present in both the first joined table and the ACL entry table to produce a second joined table. The query also includes joining the second joined table with a second Domain-Model-sub-class table based on an ACL security identity present in both the second joined table and the second Domain-Model-sub-class table to produce a third joined table.

### BACKGROUND

Relational databases facilitate searching and report generation. A relational database generally contains multiple tables of data that are related to one another in various ways. Various security restrictions may be imposed on various data in a database. The restrictions may be that certain data is read-only, both readable and writeable, etc. The restrictions may be imposed based on, for example, users or roles. For example, only personnel in the accounting department may have access to the company's accounting data, and thus accounting data in the company's database may be accessible only to users assigned an accounting role.

One example of security that can be applied to a relational database involves the use of an access control list (ACL). An ACL comprises a list of permissions attached to an object represented by a database record. An ACL specifies, for example, which users or roles are granted access to certain objects, as well as what operations are allowed for given objects.

Sometimes, there may be a desire to retrieve from a database a list of objects of a certain type to which a specific user or role is granted certain permissions. One approach to identify such objects is to query a database to return all objects of the specific type with their corresponding ACLs, and then programmatically determine to which subset of objects from the database the specific user or role has been granted the specific permission. Such systems require multiple queries, involve retrieving all records from the database containing the target subset of data, and then analyzing the permissions assigned to each record. Such queries can be undesirably time-consuming, particularly for large databases.

### BRIEF DESCRIPTION OF THE DRAWINGS

For a detailed description of various examples, reference will now be made to the accompanying drawings in which:

FIG. 1 shows a system in accordance with various examples;

FIG. 2 shows an entity relationship diagram in accordance with various examples;

FIG. 3 shows a method in accordance with various examples; and

FIG. 4 illustrates an example of a multi-join process.

### DETAILED DESCRIPTION

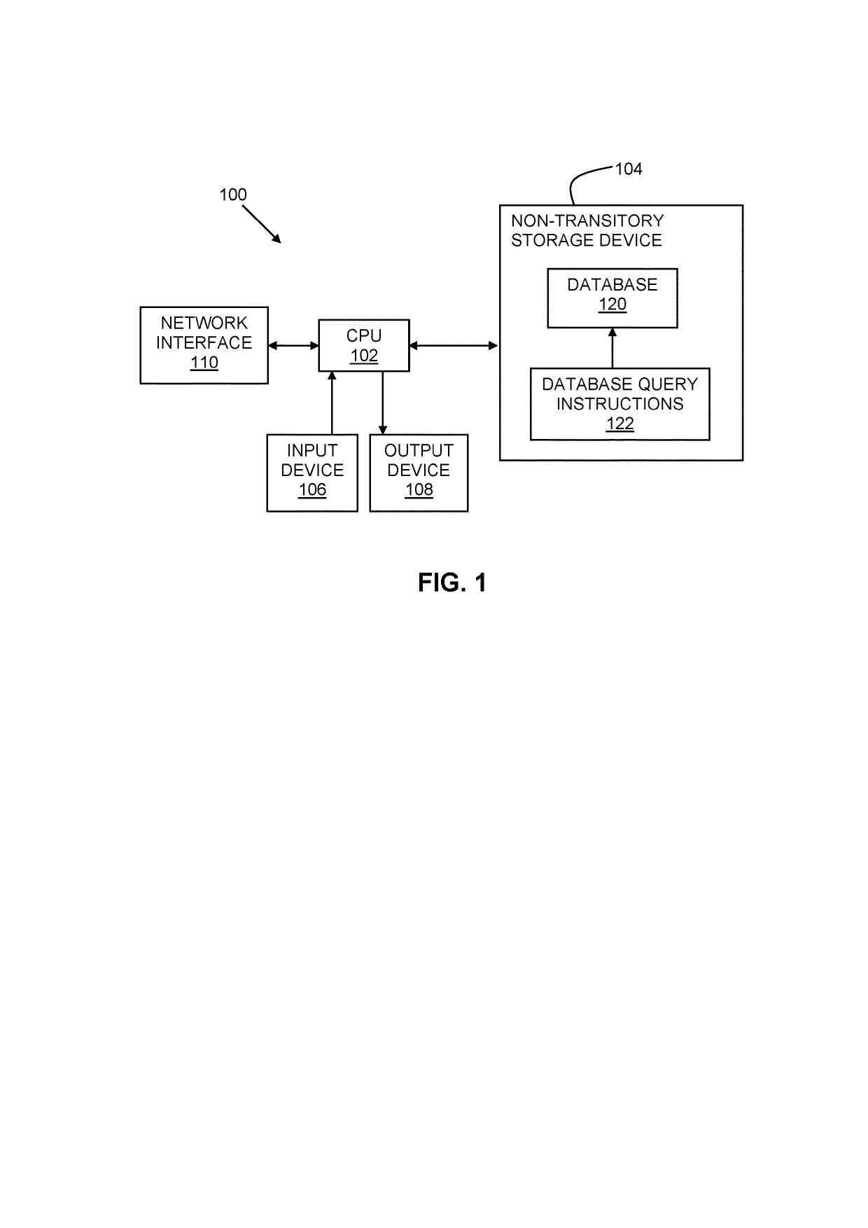

FIG. 1 illustrates a system 100 in accordance with various examples comprising a central processing unit (CPU) 102 coupled to a non-transitory storage device 104, an input device 106, an output device 108, and a network interface 110. Although a single CPU 102 is shown in the example of FIG. 1, more than one CPU can be included as desired. The input device 106 may include a keyboard, a mouse, a trackball, or other type of user input device. The output device may include a display, printer, or other type of device on which information may be presented to a user. The network interface 110 provides network connectivity to the system 100.

The non-transitory storage device 104 may comprise any suitable type of storage device such as one or more of random access memory (RAM), hard disk drive, Flash storage, etc. The non-transitory storage device 104 may comprise a single storage device or a collection of storage devices of the same or different type. The non-transitory storage device 104 includes a database 120 and database query instructions 122. The database query instructions 122 comprise software that is executable by the CPU 102 to impart the system 100 with some or all of the functionality described herein.

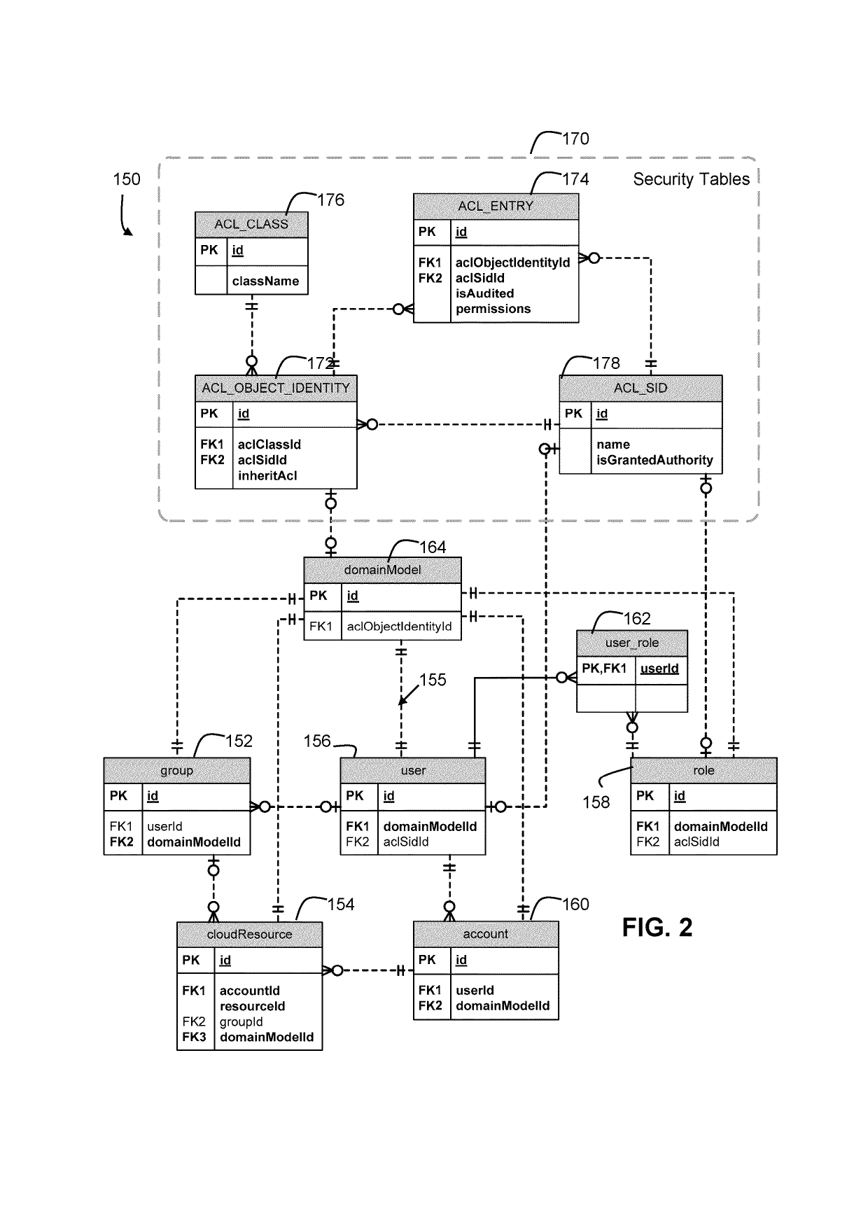

The database 120 may be implemented as a relational database that stores any desired type of data. An example of data contained in the database 120 is illustrated with regard to FIG. 2, described below, but in general the data contained in the database 120 can be any type of data used for any purpose.

The CPU 102 executes the database query instructions 122 to perform a query of the database 120 in accordance with a request from a user. The query request may be provided by the user via the input device 106 and/or via the network interface 110. The query request causes the CPU 102, upon execution of database query instructions 122, to process the database 120 as described below. The schema design of the various objects and relationships between objects in the database 120 facilitates efficient queries to be performed. For example, a single query with multiple join operations of objects in the database that have certain permission settings for certain users or roles can be performed efficiently and quickly. The schema design of the database facilitates a multi-join, single query to be performed in accordance with various embodiments. Such queries are explained in greater detail below.

FIG. 2 shows an example of an entity relationship diagram (ERD) 150 for database 120 in accordance with various embodiments. The ERD 150 illustrates and defines the schema design for the database. The example ERD 150 of FIG. 2 comprises multiple tables 152, 154, 156, 158, 160, 162, and 164. Each table 152, 154, 156, 158, 160, 162, and 164 represents a class of things such as users, groups, etc. These things generally may be called “domain objects” and the tables describing these objects can be called “domain object models” or “domain object types.” Each of the tables 152, 154, 156, 158, 160, 162, and 164 includes domain objects (e.g., records). The terms “table,” “domain object model,” “domain model,” and “domain object type” are used interchangeably in this disclosure. “Record,” “object” and “domain object” are also used interchangeably. The records in each table 152, 154, 156, 158, 160, 162, and 164 not explicitly shown in FIG. 2. For each table, what is shown includes a domain object name and primary and foreign keys (PK, FK). The keys are attributes of the domain objects. Table 152 is designated as a “Group” and provides data pertaining to various groups within an organization. Table 154 is designated as “Cloud Resource” and provides data pertaining to various cloud resources available to the organization. Examples of cloud resources include processors, storage, services, etc. Tables 156 and 158 are designated as “User” and “Role,” respectively. The User table 156 specifies the various users within an organization. Users may be, for example, the employees within the organization. The Role table 158 defines the various roles within the organization. Examples of roles include manager, accounting, president, information technology (IT) support, etc. The Account table 160 defines the various accounts that may be managed by the organization. The User Role table 162 defines the assignment of roles to users. The Domain-Model table 164 is designated as a superclass to the subordinate tables 152-162 and is used to abstract common information (e.g., a relationship to the ACL_Object_Identity) table 172 that all the sub-class tables inherit.

The various dashed lines in FIG. 2 define the relationships between the various tables 152-164. For example, the Domain-Model table 164 is connected to the User table 156 via dashed line 155. The dashed line 155 denotes that the User table 156 is related to the Domain-Model table 164 in a one-to-one relationship (the double parallel line symbol at each end of the dashed line indicates a one-to-one relationship). That the User table 156 is drawn below the Domain-Model table 164 indicates that the Domain-Model table 164 is a “super-class” with respect to the User table 156, and that the User table 156 is a “sub-class” with respect to Domain table 164. As shown, the Group, Cloud Resource, User, Role, and Account tables 152-160 are sub-class tables to the super-class Domain-Model table 164. As a sub-class table to a super-class table, a sub-class table inherits something (e.g., an ID field) from the super-class table. The example ERD 150 of FIG. 2 thus defines a hierarchical relationship among the various classes of data in the database 120. The types of data represented in the database 120, as well the relationships between the various classes of data, can be whatever is desired. In some examples, the sub-class tables of the Domain-Model table 164 all inherit a relationship to the ACL_Object_Identity table 172 from the sub-class table 164. Tables 152-162 are all domain model sub-class tables with respect to the Domain-Model-super-class table 164.

As noted above, the various tables 152-164 have primary keys (PK) and foreign keys (FK). Various primary and foreign keys map to one another to define the relationships between the various tables in the database. For example, the foreign key FK3 (domainModelID) in the Cloud Resource table 154 matches a primary key (PK) ID in the Domain-Model table 164 thereby mapping a particular cloud resource record to a record in the Domain-Model table 164. A primary key uniquely identifies each instance of the domain object type defined by the corresponding table. A foreign key is an attribute of a domain object whose value matches a primary key of a related super-class domain object. In the example of FIG. 2, each of the tables that are sub-classes to the Domain-Model table 164 have a foreign key designated as domainModelId which matches a primary key ID in the Domain-Model table 164 thereby defining the relationships shown between the sub-class tables 152-160 and the super-class table 164.

The ERD 150 of FIG. 2 also includes multiple security tables 170. The security tables 170 of FIG. 2 may be implemented in accordance with the Spring Security framework, although other security frameworks may be used as well. Spring Security is a highly customizable authentication and access-control framework. The Spring Security framework is available under an open source software license.

The security tables 170 implement access control lists (ACLs). Each domain object may be assigned its own ACL. As specified in tables 170, each ACL contains the permissions pertaining to the associated domain object. The security tables 170 in the example of FIG. 2 include the four tables shown—ACL_Object_Identity table 172, ACL_Entry table 174, ACL_Class table 176, and ACL_SID table 178.

The ACL_SID table 178 (“SID” refers to Security Identity) uniquely identifies all principals and Granted Authorities in the system. A principal is a user. A Granted Authority is a role that can be assigned to a user. The ACL_SID table 178 contains three columns in some implementations—one column for the ID, another column for the textual representation of the SID, and a third column for a flag to indicate whether the textual representation refers to a principal (i.e., a user) or a Granted Authority (i.e., a role). This table includes a row for each unique principal or Granted Authority.

The ACL_Class table 176 uniquely identifies domain objects (type/model) in the system. In some implementations, ACL_Class table 176 includes a column for ID and a column for the class name, and one row for each unique class for whose object (instances) permissions are to be provided.

The ACL_Object_Identity table 172 stores information for each unique domain object in the system. The ACL_Object_Identity table 172 may include columns for ID, a foreign key to the ACL_Class table 176, a unique identifier to identify the corresponding ACL_Class, a foreign key to the ACL_SID table 178 to represent the owner of the domain objet instance, and whether ACL entries are allowed to inherit from any parent ACL. Table 176 includes a record for every domain object for which ACL permissions are stored.

The ACL_Entry table 174 stores individual permissions assigned to each SID. Columns of the ACL_Entry table 174 may include a foreign key to the ACL_Object_Identity table 172, the SID (e.g., a foreign key to the ACL_SID table 178), whether auditing is permitted or not, and an integer bit mask that represents the actual permission being granted or denied. A row is provided in table 174 for each combination of SID and domain object whereas the SID receives a permission to work with that domain object.

Normally, due to the separation between domain objects of modern software systems and implementation of ACL frameworks such as Spring Security ACL, retrieval of a complete set of domain objects unfortunately and inefficiently is performed first to loading a list of objects in memory, before such objects then can be checked one-by-one against ACLs for permission attributes. In such systems, ACL_ENTRY records are queried and loaded one-by-one for the determination of permission in-memory. In the implementations disclosed herein, a single query may be used to identify domain objects of the desired permissions.

Referring still to FIG. 2, the User and Role tables 156 and 158 have a foreign key (FK2) labeled as aclSidId. Further, the Domain-Model table 164 has a foreign key (FK1) labeled as aclObjectIdentityId. These particular foreign keys have been included in the example ERD 150 depicted in FIG. 2 to facilitate searches of the database. These added foreign keys permit a single query with multiple “join” operations to be performed as described below.

A join operation combines records from two or more tables in a database. A join operation combines fields from multiple tables using values common to each table. A join operation creates a data set that can be saved as table itself or used as is. Multiple types of join operations are possible. The example provided below uses an “inner join” operation. An inner join operation combines column values from multiple tables based upon a join-predicate. For example, performing an inner join on tables A and B entails comparing each row of table A with each row of table B to find all pairs of rows which satisfy the join-predicate. When the join-predicate is satisfied, column values for each matched pair of rows of tables A and B are combined into a result row.

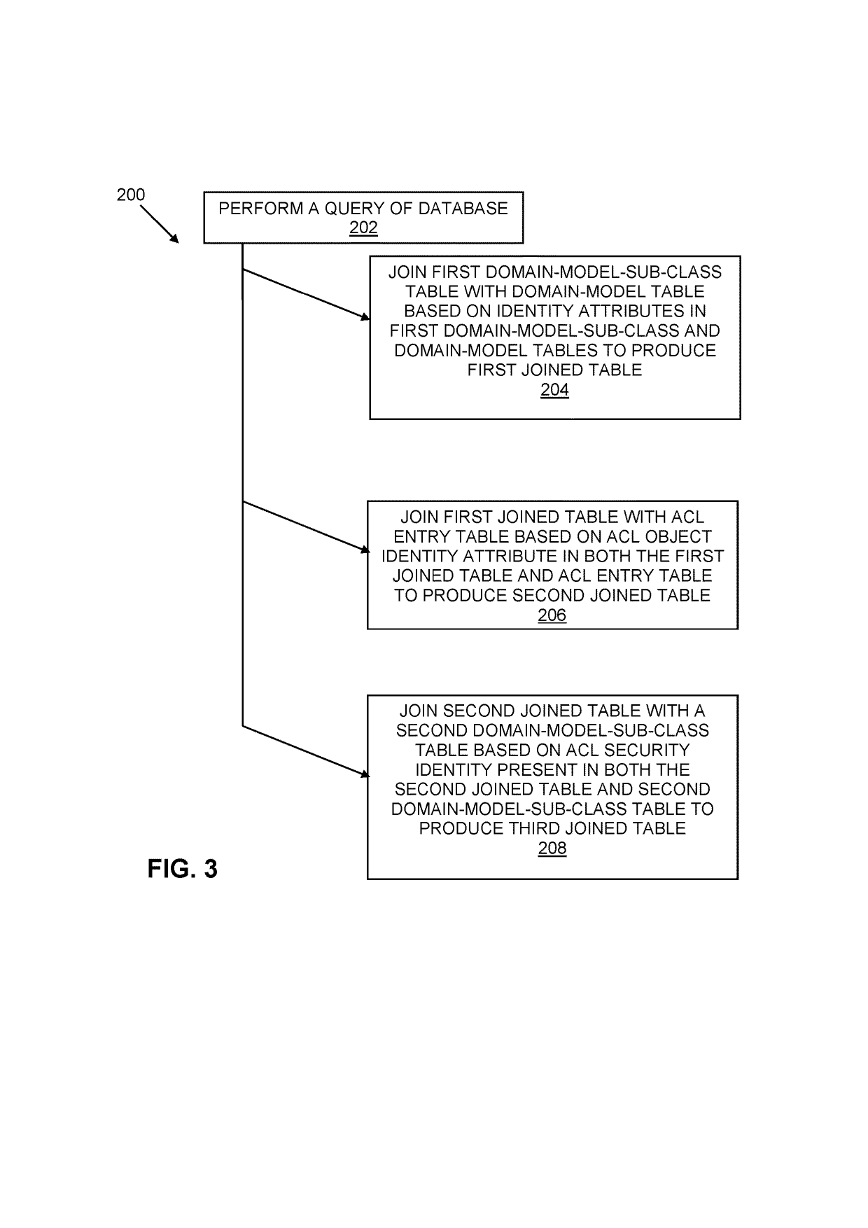

FIG. 3 illustrates an example of a method 200 in which a query (e.g., a single query) is performed (202). The query 202 includes three join operations 204, 206, and 208. The first join operation 204 includes joining a first DomainModel-sub-class table with the Domain-Model table based on identity attributes present in both the first DomainModel-sub-class table and the Domain Model table to produce a first joined table. The second join operation 206 includes joining the first joined table with an access control list (ACL) entry table based on an ACL object identity attribute present in both the first joined table and the ACL entry table to produce a second joined table. The third join operation in the example of FIG. 3 includes joining the second joined table with a second DomainModel-sub-class table based on an ACL security identity present in both the second joined table and the second DomainModel-sub-class table to produce a third joined table. The third joined table therefore includes records from the first DomainModel-sub-class table, the DomainModel table, the ACL entry table, and a second DomainModel-sub-class table (e.g., the Role table 158). The third joined table (which combines records from multiple tables in the database) can be filtered as desired based on a filtering parameter.

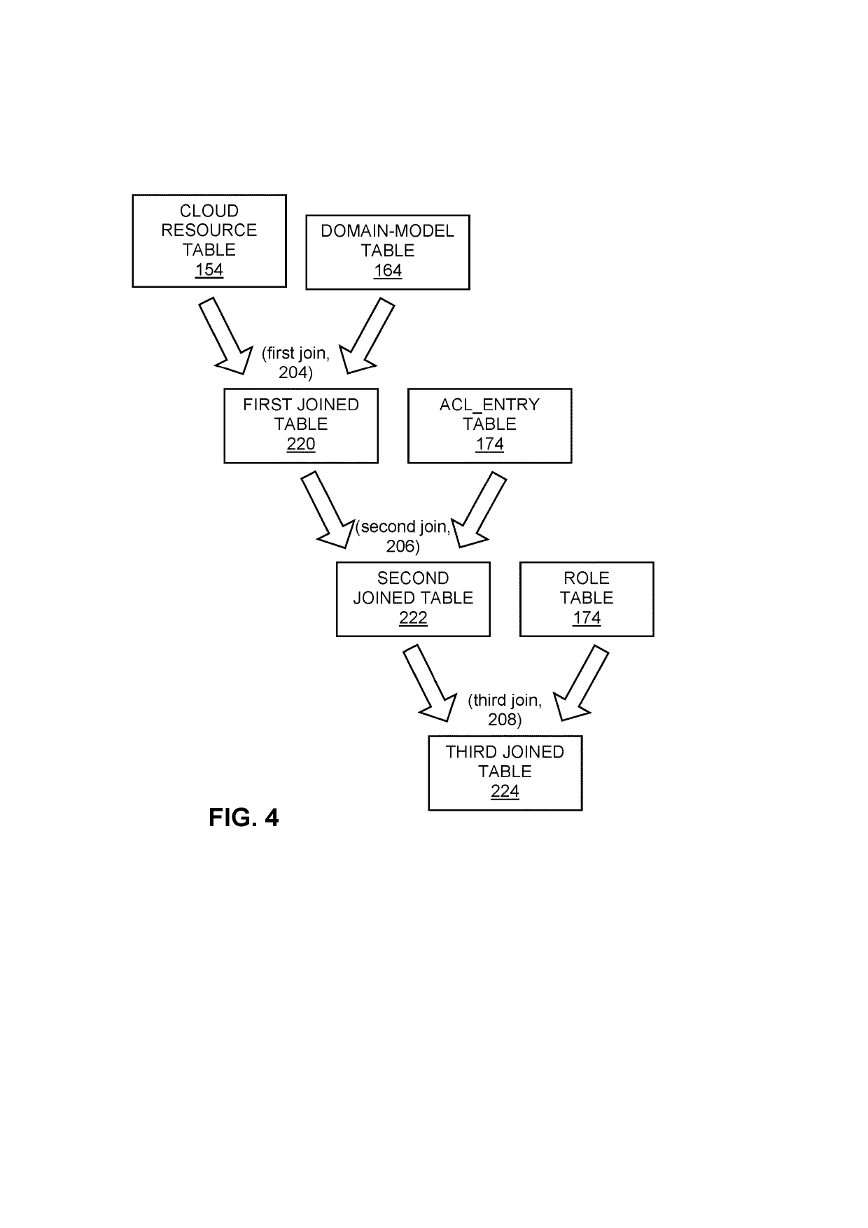

The following illustrates an example of the application of method 200 to a database whose schema is reflected by the ERD 150 of FIG. 2. FIG. 4 further illustrates the following example and is referenced below. The following single Structured Query Language (SQL) query retrieves all cloud resource records for which a specific role having ID 18 has a read permission:

SELECT c.* FROM cloudResource c

INNER JOIN domainModel d ON c.domainModelId=d.id

INNER JOIN ACL_ENTRY n ON d.aclObjecIdentityId=n.aclObjectIdentityId

INNER JOIN role r ON n.aclSidId=r.aclSidId

WHERE r.id=18 AND (n.permission & 2=2)

The SELECT c.* FROM cloudResource c command selects all records from the Cloud Resource table 154. The Cloud Resource table is referred to by the letter “c.”

The first inner join command (INNER JOIN domainModel d ON c.domainModelId=d.id) performs an inner join operation on the Cloud Resource domain table 154 and the Domain-Model table 164 (referred to by the letter “d”). The join-predicate on which the first inner join is performed is the ID primary key field of the Domain-Model table 164. That is, the first inner join determines all records in the Cloud Resource table 154 that have a domainModelID foreign key that matches the ID primary key of a record in the Domain-Model table 164. The matching rows are found and placed in a resulting table referred to as the first joined table (220, FIG. 4) in the join operation 204 of FIG. 3.

In the second join command above (INNER JOIN ACL_ENTRY n ON d.aclObjecIdentityId=n.aclObjectIdentityId), the result of the first join operation command above is then joined with the ACL_Entry table 174 based on a join-predicate of aclObjectIdentityId. This second join command finds each pair of records in the first joined table (resulting from the first join command) and in the ACL_Entry table 174 that have the same aclObjectIdentityId. Each such matching pair of records are joined together to produce a second joined table 222 (join operation 206 from FIG. 3).

In the third join command above (INNER JOIN role r ON n.aclSidId=r.aclSidId), the result of the second join operation command is then joined with the Role table 158 based on a join-predicate of aclSidId. This third join command finds each pair of rows in the second joined table (resulting from the second join command) and in the Role table 158 that have the same aclSidId. Each such matching pair of rows are joined together to produce a third joined table 224 (join operation 208 from FIG. 3). As such, one query having three join operations has been performed to produce the third joined table.

The last command above (WHERE r.id=18 AND (n.permission & 2=2)) causes the third joined table to be filtered based on a filtering parameter that the Role is 18 and permission is 2. The Role number (18 in this example) is whichever particular role in which the user performing the search is interested. For example Role 18 may correspond to Accounting. Permission 2 also corresponds to whichever permission in which the user is interested (the read permission in this example). As a result, all cloud resource records are retrieved on which a specific role having ID 18 has a read permission.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method, comprising:
performing a query of a database;
wherein performing the query comprises:
joining a first Domain-Model-sub-class table with a Domain-Model table based on identity attributes present in both the first Domain-Model-sub-class and Domain-Model tables to produce a first joined table;
joining the first joined table with an access control list (ACL) entry table based on an ACL object identity attribute present in both the first joined table and the ACL entry table to produce a second joined table; and
joining the second joined table with a second Domain-Model-sub-class table based on an ACL security identity present in both the second joined table and the second Domain-Model-sub-class table to produce a third joined table.

2. The method of claim 1 further comprising filtering the third joined table based on a specified filtering parameter.

3. The method of claim 1 where all of the joinings are part of a single query.

4. A machine-readable storage device comprising machine-readable instructions that, when executed, cause a central processing unit (CPU) to:
perform a query of a database by:
joining a first Domain-Model-sub-class table with a Domain-Model table based on a identity attributes present in both the first Domain-Model-sub-class table and Domain-Model table to produce a first joined table;
joining the first joined table with an access control list (ACL) entry table based on an ACL object identity attribute present in both the first joined table and the ACL entry table to produce a second joined table; and
joining the second joined table with a second Domain-Model-sub-class table based on an ACL security identity present in both the second joined table and the second Domain-Model-sub-class table to produce a third joined table.

5. The machine-readable storage device of claim 4 wherein the machine-readable instructions further cause the CPU to perform the query by filtering the third joined table based on a specified filtering parameter.

6. The machine-readable storage device of claim 4 wherein the machine-readable instructions, when executed, cause the CPU to perform said joins as part of a single query.

7. A system, comprising:
a central processing unit (CPU); and
storage coupled to said CPU and containing a database;
wherein said database comprises a plurality of Domain-Model-sub-class tables, a Domain Model superclass table, and an access control list (ACL) entry table;
wherein each Domain-Model-sub-class table comprises a domain model identifier attribute, said Domain-Model superclass table comprising identifier and ACL object identity identifier attributes, said ACL entry table comprises ACL object identity identifier and ACL security identity identifier attributes, and at least one Domain-Model-sub-class table also comprising an ACL security identity identifier attribute; and
wherein said CPU is to respond to a query request by performing a plurality of join operations on at least one Domain-Model-sub-class table, the Domain-Model superclass table, the ACL entry table, and the at least one Domain-Model-sub-class table that comprises an ACL security identity identifier attribute.

8. The system of claim 7 wherein the plurality of join operations includes three join operations within a single query.

9. The system of claim 7 wherein the plurality of join operations include:
a join of a first Domain-Model-sub-class table with the Domain-Model superclass table based on a identity attributes present in both the first Domain-Model-sub-class table and Domain-Model superclass table to produce a first joined table;
a join of the first joined table with the ACL entry table based on an ACL object identity attribute present in both the first joined table and the ACL entry table to produce a second joined table; and
join of the second joined table with a second Domain-Model-sub-class table based on an ACL security identity present in both the second joined table and the second Domain-Model-sub-class table to produce a third joined table.

10. The system of claim 7 wherein the CPU is to filter the third joined table based on a specified filtering parameter.
